(19) United States
(12) Patent Application Publication
(10) Pub. No.: US 2007/0059080 A1
(43) Pub. Date: Mar. 15, 2007

(54) Take-up spool for a printer

(75) Inventors: Kia Silverbrook, Balmain (AU); Nagesh Ramachandra, Balmain (AU); Jan Waszczuk, Balmain (AU)

Correspondence Address: SILVERBROOK RESEARCH PTY LTD, 393 DARLING STREET, BALMAIN, NSW 2041, AU

(73) Assignee: Silverbrook Research Pty Ltd

(21) Appl. No.: 11/223,021

(22) Filed: Sep. 12, 2005

(51) Int. Cl. B41J 15/04; B41J 15/16

(52) U.S. Cl. 400/614; 400/613

(57) ABSTRACT

A take-up spool for a wide format printer is provided. The spool comprises a radially expandable shaft and at least one expander releasably engageable with the shaft. Engagement of the expander with the shaft radially expands at least part of the shaft. Expansion and contraction of the shaft facilitates removal of a web of print media wound onto the shaft.

### CROSS REFERENCES TO RELATED APPLICATIONS

Various methods, systems and apparatus relating to the present invention are disclosed in the following co-pending applications filed by the applicant or assignee of the present invention. The disclosures of all of these co-pending applications and granted patents are incorporated herein by cross-reference.

| | | | | | | |
|---|---|---|---|---|---|---|
| 09/517539 | 6566858 | 09/112762 | 6331946 | 6246970 | 6442525 | 09/517384 |
| 09/505951 | 6374354 | 09/517608 | 6816968 | 6757832 | 6334190 | 6745331 |
| 09/517541 | 10/203559 | 10/203560 | 10/203564 | 10/636263 | 10/636283 | 10/866608 |
| 10/902889 | 10/902833 | 10/940653 | 10/942858 | 10/727181 | 10/727162 | 10/727163 |
| 10/727245 | 10/727204 | 10/727233 | 10/727280 | 10/727157 | 10/727178 | 10/727210 |
| 10/727257 | 10/727238 | 10/727251 | 10/727159 | 10/727180 | 10/727179 | 10/727192 |
| 10/727274 | 10/727164 | 10/727161 | 10/727198 | 10/727158 | 10/754536 | 10/754938 |
| 10/727227 | 10/727160 | 10/934720 | 10/296522 | 6795215 | 10/296535 | 09/575109 |
| 6805419 | 6859289 | 09/607985 | 6398332 | 6394573 | 6622923 | 6747760 |
| 6921144 | 10/884881 | 10/943941 | 10/949294 | 11/039866 | 11/123011 | 11/123010 |
| 11/144769 | 11/148237 | 10/922846 | 10/922845 | 10/854521 | 10/854522 | 10/854488 |
| 10/854487 | 10/854503 | 10/854504 | 10/854509 | 10/854510 | 10/854496 | 10/854497 |
| 10/854495 | 10/854498 | 10/854511 | 10/854512 | 10/854525 | 10/854526 | 10/854516 |
| 10/854508 | 10/854507 | 10/854515 | 10/854506 | 10/854505 | 10/854493 | 10/854494 |
| 10/854489 | 10/854490 | 10/854492 | 10/854491 | 10/854528 | 10/854523 | 10/854527 |
| 10/854524 | 10/854520 | 10/854514 | 10/854519 | 10/854513 | 10/854499 | 10/854501 |
| 10/854500 | 10/854502 | 10/854518 | 10/854517 | 10/934628 | 10/728804 | 10/728952 |
| 10/728806 | 10/728834 | 10/729790 | 10/728884 | 10/728970 | 10/728784 | 10/728783 |
| 10/728925 | 10/728842 | 10/728803 | 10/728780 | 10/728779 | 10/773189 | 10/773204 |
| 10/773198 | 10/773199 | 6830318 | 10/773201 | 10/773191 | 10/773183 | 10/773195 |
| 10/773196 | 10/773186 | 10/773200 | 10/773185 | 10/773192 | 10/773197 | 10/773203 |
| 10/773187 | 10/773202 | 10/773188 | 10/773194 | 10/773193 | 10/773184 | 11/008118 |
| 11/060751 | 11/060805 | 11/188017 | 6623101 | 6406129 | 6505916 | 6457809 |
| 6550895 | 6457812 | 10/296434 | 6428133 | 6746105 | 10/407212 | 10/407207 |
| 10/683064 | 10/683041 | 6750901 | 6476863 | 6788336 | 11/097308 | 11/097309 |
| 11/097335 | 11/097299 | 11/097310 | 11/097213 | 11/097212 | 10/760272 | 10/760273 |
| 10/760187 | 10/760182 | 10/760188 | 10/760218 | 10/760217 | 10/760216 | 10/760233 |
| 10/760246 | 10/760212 | 10/760243 | 10/760201 | 10/760185 | 10/760253 | 10/760255 |
| 10/760209 | 10/760208 | 10/760194 | 10/760238 | 10/760234 | 10/760235 | 10/760183 |
| 10/760189 | 10/760262 | 10/760232 | 10/760231 | 10/760200 | 10/760190 | 10/760191 |
| 10/760227 | 10/760207 | 10/760181 | 10/815625 | 10/815624 | 10/815628 | 10/913375 |
| 10/913373 | 10/913374 | 10/913372 | 10/913377 | 10/913378 | 10/913380 | 10/913379 |
| 10/913376 | 10/913381 | 10/986402 | 11/172816 | 11/172815 | 11/172814 | 11/003786 |
| 11/003354 | 11/003616 | 11/003418 | 11/003334 | 11/003600 | 11/003404 | 11/003419 |
| 11/003700 | 11/003601 | 11/003618 | 11/003615 | 11/003337 | 11/003698 | 11/003420 |
| 11/003682 | 11/003699 | 11/071473 | 11/003463 | 11/003701 | 11/003683 | 11/003614 |
| 11/003702 | 11/003684 | 11/003619 | 11/003617 | 10/760254 | 10/760210 | 10/760202 |
| 10/760197 | 10/760198 | 10/760249 | 10/760263 | 10/760196 | 10/760247 | 10/760223 |
| 10/760264 | 10/760244 | 10/760245 | 10/760222 | 10/760248 | 10/760236 | 10/760192 |
| 10/760203 | 10/760204 | 10/760205 | 10/760206 | 10/760267 | 10/760270 | 10/760259 |
| 10/760271 | 10/760275 | 10/760274 | 10/760268 | 10/760184 | 10/760195 | 10/760186 |
| 10/760261 | 10/760258 | 11/014764 | 11/014763 | 11/014748 | 11/014747 | 11/014761 |
| 11/014760 | 11/014757 | 11/014714 | 11/014713 | 11/014762 | 11/014724 | 11/014723 |
| 11/014756 | 11/014736 | 11/014759 | 11/014758 | 11/014725 | 11/014739 | 11/014738 |
| 11/014737 | 11/014726 | 11/014745 | 11/014712 | 11/014715 | 11/014751 | 11/014735 |
| 11/014734 | 11/014719 | 11/014750 | 11/014749 | 11/014746 | 11/014769 | 11/014729 |
| 11/014743 | 11/014733 | 11/014754 | 11/014755 | 11/014765 | 11/014766 | 11/014740 |
| 11/014720 | 11/014753 | 11/014752 | 11/014744 | 11/014741 | 11/014768 | 11/014767 |
| 11/014718 | 11/014717 | 11/014716 | 11/014732 | 11/014742 | 11/097268 | 11/097185 |
| 11/097184 | 09/575197 | 09/575195 | 09/575159 | 09/575132 | 09/575123 | 6825945 |
| 09/575130 | 09/575165 | 6813039 | 09/575118 | 09/575131 | 09/575116 | 6816274 |
| 09/575139 | 09/575186 | 6681045 | 6728000 | 09/575145 | 09/575192 | 09/575181 |
| 09/575193 | 09/575156 | 6789194 | 09/575150 | 6789191 | 6644642 | 6502614 |
| 6622999 | 6669385 | 6549935 | 6727996 | 6591884 | 6439706 | 6760119 |
| 09/575198 | 6290349 | 6428155 | 6785016 | 6870966 | 6822639 | 6737591 |
| 09/575154 | 09/575129 | 6830196 | 6832717 | 09/575189 | 09/575162 | 09/575172 |
| 09/575170 | 09/575171 | 09/575161 | | | | |

### CO-PENDING APPLICATIONS

The following applications have been filed by the Applicant simultaneously with the present application:

| | | | | |
|---|---|---|---|---|
| WFP4US | WFP6US | WFP8US | WFP12US | WFP13US |
| WFP14US | | | | |

The disclosures of these co-pending applications are incorporated herein by reference. The above applications have been identified by their filing docket number, which will be substituted with the corresponding application number, once assigned.

### FIELD OF THE INVENTION

The present invention relates to a spool for a printer. It has been developed primarily to facilitate removal of a web of print media from a take-up spool.

### BACKGROUND OF THE INVENTION

In general, there are two methods of feeding print media (e.g. paper) past a printhead in a printer. Desktop printers typically feed individual sheets of paper from a stack of paper held in a paper tray. Individual sheets of paper are taken from the top of the stack on demand and fed past the printhead.

In large-scale wide format printing, the print media is typically a continuous web. The web of print media is supplied as, for example, a roll of paper, which can be fitted onto a supply spool in the printer. During printing, the web is fed from the supply spool, past a printhead and onto a take-up spool. Usually, a drive roller system, comprised of a pair of grippingly engaged rollers, is positioned between the supply spool and the take-up spool. The drive roller system feeds the web past the printhead on demand.

In all commercially available wide format printers, a scanning printhead is employed to deposit ink on the web of print media. In such printers, the web must be stationary as the printhead traverses across the web. After each scan of the printhead, the web moves forward and the printhead scans across again, depositing the next line of an image.

U.S. Pat. No. 6,672,706 (Silverbrook) describes a wide format pagewidth inkjet printer. In this wide format pagewidth printer, the web is continuously fed past a pagewidth printhead. The pagewidth printhead makes high-speed wide format printing possible by “printing-on-the-fly”—that is, continuously feeding a web and simultaneously printing without the web having to be stationary at any stage.

It will be appreciated that, in order to achieve “printing-on-the-fly”, it is important that the delivery of the media is finely controlled to achieve consistent print quality. Any variation in web speed or web tension would result in a deterioration in print quality in the form of, for example, a distorted printed image. A constant web speed and web tension requires not only a reliable feed motor system, but also secure attachment of the web between the supply spool and the take-up spool. In particular, the web of print media needs to be securely attached to the take-up spool in such a way that it can be easily removed once printing has finished.

Current methods for securing the print media to the take-up spool are cumbersome and, moreover, do not allow convenient removal of the print media from the take-up spool once printing has finished. The usual method is to fit a cardboard core (from a previously used paper roll) onto the take-up spool and fasten the web to the cardboard core using adhesive tape. Printing can then begin by actuating the printhead whilst automatically feeding print media from the supply spool to the take-up spool using a motorized feed mechanism. After printing, the web is cut adjacent the printhead, and the cardboard core (with the printed paper wound on it) is removed by sliding it off the take-up spool. The printed paper roll is trimmed to size on a trimming machine and the cardboard core is recovered for re-use. Instead of recovering and re-using the cardboard core, a supply of fresh cardboard core may be used for successive print runs.

A problem with this method of loading and unloading the take-up spool is that the user needs to use adhesive tape or similar, which is awkward and not always conveniently available. A further problem is that a supply of empty take-up spools is required in order to run successive print jobs.

It would be desirable to provide a spool, such as a take-up spool for a wide format printer, which simplifies the operation of removing a web of material therefrom enabling the spool to be easily re-used in successive print runs.

It would further be desirable to provide a spool, such as a take-up spool for a wide-format printer, which simplifies the operation of releasably securing a web of material thereto. It would be particularly desirable to provide a spool, which obviates the need for adhesive tape or similar when securing a web thereto.

### SUMMARY OF THE INVENTION

In a first aspect, the present invention provides a spool for a printer comprising:

a radially expandable shaft; and

at least one expander releasably engageable with the shaft,

wherein engagement of the expander with the shaft radially expands at least part of the shaft.

In a second aspect, the present invention provides a printer comprising:
a printhead; and
a feed mechanism for feeding a web of print media past said printhead, said feed mechanism comprising:
   a supply spool;
   a take-up spool as described above; and
   a take-up motor operatively connected to said take-up spool.

In a third aspect, the present invention provides a method of printing comprising the steps of:
(i) feeding a web of print media from a supply spool to a radially expanded take-up spool, whilst simultaneously printing onto said print media, thereby providing a printed roll of print media wound onto said radially expanded take-up spool;
(ii) radially contracting said take-up spool once printing is completed; and
(iii) removing said printed roll of print media from said radially contracted take-up spool.

In a fourth aspect, the present invention provides a method of printing comprising:

(i) providing a printhead;

(ii) providing a feed mechanism for feeding a web of print media past said printhead, said feed mechanism comprising:
a supply spool;
a radially expanded take-up spool; and
a take-up motor operatively connected to said take-up spool;

(iii) feeding a web of print media from said supply spool to said radially expanded take-up spool whilst simultaneously printing onto said print media using said printhead;

(iv) radially contracting said take-up spool once printing is completed; and

(v) removing said print media from said radially contracted take-up spool.

The spool of the present invention advantageously allows facile removal of a web of material wound thereon by having a radially expandable shaft. Before winding a material onto the spool, the shaft is radially expanded thereby increasing its diameter. Once the material has been wound onto the spool, the shaft is radially contracted thereby decreasing its diameter. Since the wound material maintains its relatively large core diameter after the shaft has been radially contracted, the result is that the wound material can be easily removed from the shaft by longitudinally sliding the shaft relative to the wound material.

Optionally, the shaft is expandable from a radially contracted configuration to a radially expanded configuration, the shaft being resiliently biased towards the radially contracted configuration. Resilient biasing of the shaft may be achieved by appropriate selection of the shaft material. Accordingly, the shaft is optionally formed from a resilient material, such as steel, aluminium or resilient plastics.

Optionally, the spool comprises two expanders, each expander being releasably engageable with a respective end of the shaft. Optionally, each of the expanders radially expands its respective end region of the shaft. In a typical elongate shaft, the central region may remain relatively unexpanded by the two expanders. However, provided that the two end regions are radially expanded, a wound material will easily slide off longitudinally once these end regions have been radially contracted by removal of the expanders. In practice, it is not necessary to expand radially the entire length of the shaft in order to achieve facile removal of the wound material.

Optionally, the shaft is hollow and the expanders take the form of expander plugs releasably engageable in each end of the shaft. Hence, in this form of the invention, the hollow ends of the shaft act as sockets for releasably receiving the expander plugs. The expander plugs are usually rigid relative to the shaft so that insertion of the plugs in the hollow ends of the shaft urges the corresponding end regions into radially expanded configurations. The plugs may be made relatively rigid either by selection of a more rigid material than the shaft material, or by simply having a greater thickness than the shaft material. For example, a thin-walled hollow steel shaft may be radially expanded by a thick-walled hollow steel plug or, indeed, a solid steel plug having a suitable diameter. Since, as explained above, it is only necessary to expand radially an end region of the shaft, the plug(s) usually take the form of relatively short stubs.

Optionally, the expander plug(s) are friction-fitted in the shaft. Friction-fitting provides a facile release mechanism for the plug(s). Optionally, the plugs(s) are tapered to assist friction-fitting engagement and for urging the shaft into a radially expanded configuration as the plug(s) are inserted into each end of the shaft. The amount of radial expansion in the shaft is determined by the widest diameter of each plug. Usually, the degree of radial expansion necessary at each end of the shaft to achieve facile removal of a wound material is less than about 10 mm, and typically about 2 mm. Hence, the widest diameter of each plug is selected appropriately and tapered to allow facile insertion in the shaft. The force required to insert the plug(s) is not too great and can be easily applied by the user.

Optionally, the plug(s) include a flange for guiding a web of material wound onto the spool. The flange may be in the form of a circular end-plate at one end of the plug so that the end-plate lies flush against the end of the shaft, forming a flange therewith, when the plug is inserted in the shaft. The diameter of the end-plate should be suitable for retaining an anticipated volume of material wound onto the spool. For example, in wide format printing applications, the end-plate typically has a diameter of from 5 to 30 cm.

Optionally, the shaft has a longitudinal slit. The longitudinal slit optionally extends along the entire length of the shaft and has several functions. Firstly, it allows facile radial expansion of the shaft when, for example, expander plugs are inserted in each end. Secondly, the slit allows a web of material to be securely captured by the spool without the need for adhesive tape or the like. By simply inserting a leading edge of the web inside the slit and rotating the spool, the web can be initially secured to the spool by the frictional gripping action of a longitudinal edge of the slit with a surface of the web in contact therewith. Thereafter, successive overlaying of the web against itself ensures security with the shaft.

An additional advantage of the longitudinal slit is that the web of material is, at least to some extent, naturally self-aligning once inserted in the slit. By “self-aligning”, it is meant that the material will evenly overlay against itself when the spool rotates, rather than skewing in one direction as the roll of wound material builds up on the spool. Self-alignment may be assisted by appropriate flanges. The flanges may be at each end of the shaft and, as mentioned above, the expander plugs may comprise suitable flanges. In cases where the web of material has a relatively small width dimension, the shaft may be equipped with circumferential flange(s) slidingly movable along the length of the shaft. Such slidably movable circumferential flange(s) may be positioned to guide the web of material onto the spool during initial loading and/or during subsequent printing.

Optionally, the expander plug(s) are hollow, each having a slit corresponding with and alignable with the longitudinal slit in the shaft. An advantage of this slit in the plug(s) is that the web of material can be secured to the shaft along its entire length, thereby allowing the material to lie flush against flanges at each end of the shaft. Hence, the plug slits advantageously avoid “dead space” at each end of the spool.

Optionally, the shaft and the expander plugs(s) comprise complementary guides for aligning their respective slits. The optional guides key the plug(s) into a suitably aligned orientation in the shaft. Furthermore, the guides are optionally configured to minimize rotational movement of the plug(s) relative to the shaft. The guides may take the form of, for example, complementary surface features (e.g. grooves) on the inner surface of the hollow shaft and the outer surface of the plug(s).

The spool of the present invention is preferably a take-up spool in a printer, more preferably a take-up spool in a wide format printer. However, the spool of the present invention may be used in any application where facile loading and unloading of a wound material is desired. When the spool is used as a take-up spool in a printer, at least one (preferably one) expander will optionally comprise a connector arm for operatively connecting the spool to a take-up motor. Operative connection may be by, for example a gear wheel on the connector arm, which intermeshes with a gear wheel on the motor and rotates the spool. Other standard means for connecting the spool to a motor will be readily apparent to the skilled person.

### BRIEF DESCRIPTION OF THE DRAWINGS

A preferred form of the present invention will be now be described in detail, with reference to the following drawings, in which:—

FIG. 1 is a cutaway perspective view of a wide format printer;

FIG. 2 is a schematic side view of a printhead and feed mechanism for a wide format printer;

FIG. 3 is a perspective view of the take-up spool according to the invention;

FIG. 4 is a perspective view of the take-up spool according to the invention;

FIG. 5 is a perspective view of an expander plug;

FIG. 6 is a side view of the expander plug shown in FIG. 5.

### DETAILED DESCRIPTION OF A PREFERRED EMBODIMENT

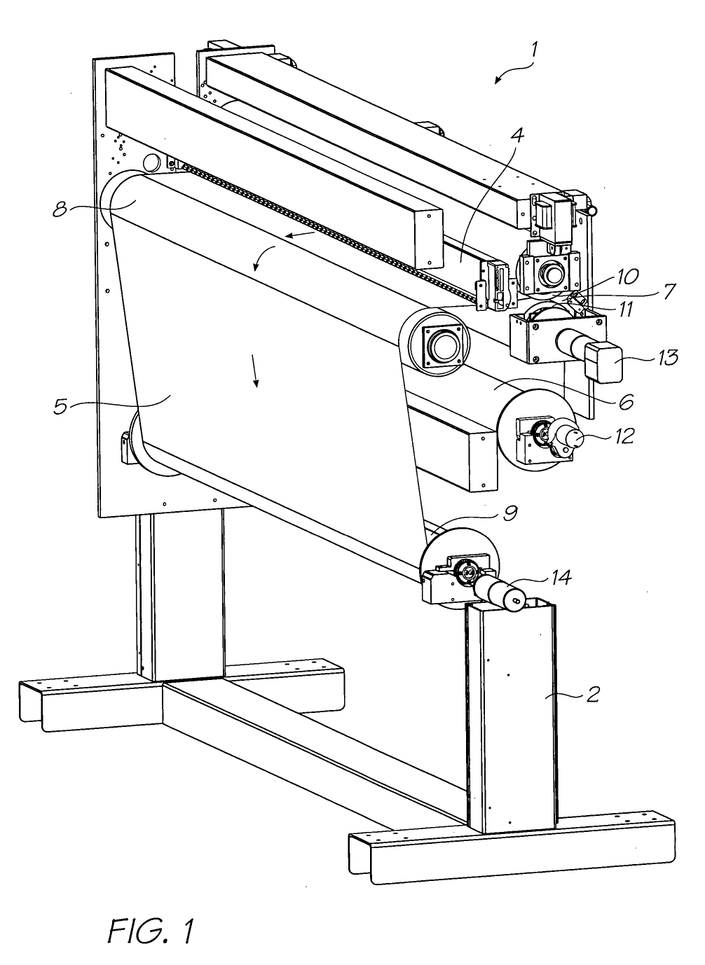

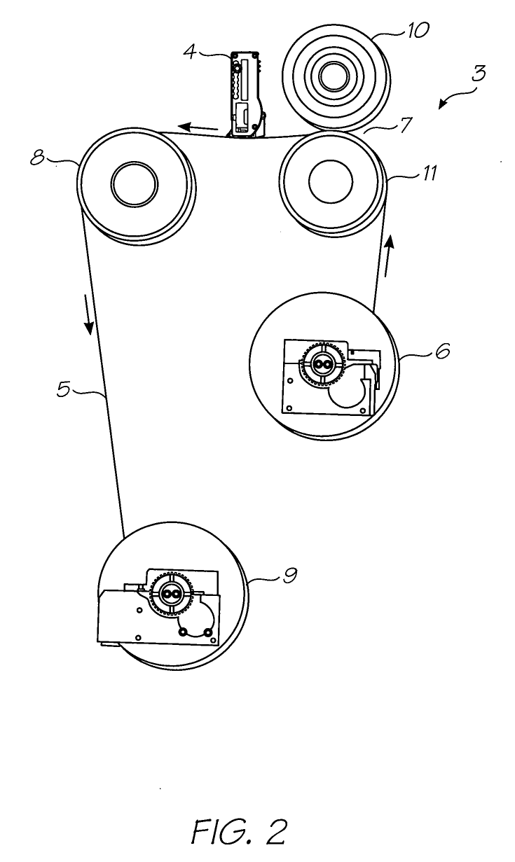

Referring to FIGS. 1 and 2 there is shown a wide format printer 1 comprising a support structure 2, which supports a feed mechanism 3 and a printhead 4. The feed mechanism 3 comprises a system of motorized rollers for feeding a web of print media 5 past the printhead 4. The printhead 4 is a pagewidth inkjet printhead, which ejects droplets of ink onto the web 5 as it is fed through a print zone adjacent the printhead 4. The direction of feed is shown by arrows on the web 5.

FIG. 2 shows in more detail the feed mechanism 3 comprising a supply spool 6, a drive roller system 7, an idle roller 8 and a take-up spool 9. The supply spool 6 is loaded with a web 5 of print media, which is fed to the drive roller system 7. The drive roller system 7 comprises an upper drive roller 10 in gripping engagement with a lower drive roller 11, the web 5 being fed between the upper drive roller 10 and the lower drive roller 11. From the drive roller system 7, the web is fed past the printhead 4, over the idle roller 8, and onto the take-up spool 9.

Various motors control the feeding of the web 5 through the feed mechanism 3. The supply spool 6 is connected to a braking motor 12, which provides a resistive force and generates tension in the web 5. The main driving force in the feed mechanism 3 is provided by a drive motor 13 connected to the lower drive roller 11. The lower drive roller 11, in combination with the upper driver roller 10 grippingly engaged therewith, drives the web 5 past the printhead 4 at a constant rate.

A take-up motor 14 is connected to the take-up spool 9. The combination of the braking motor 12, the drive motor 13 and the take-up motor 14 maintains constant tension in the web 5 during printing. The maintenance of constant tension in the web 5 is particularly important in high-speed printing in order to avoid paper crumpling and/or poor print quality.

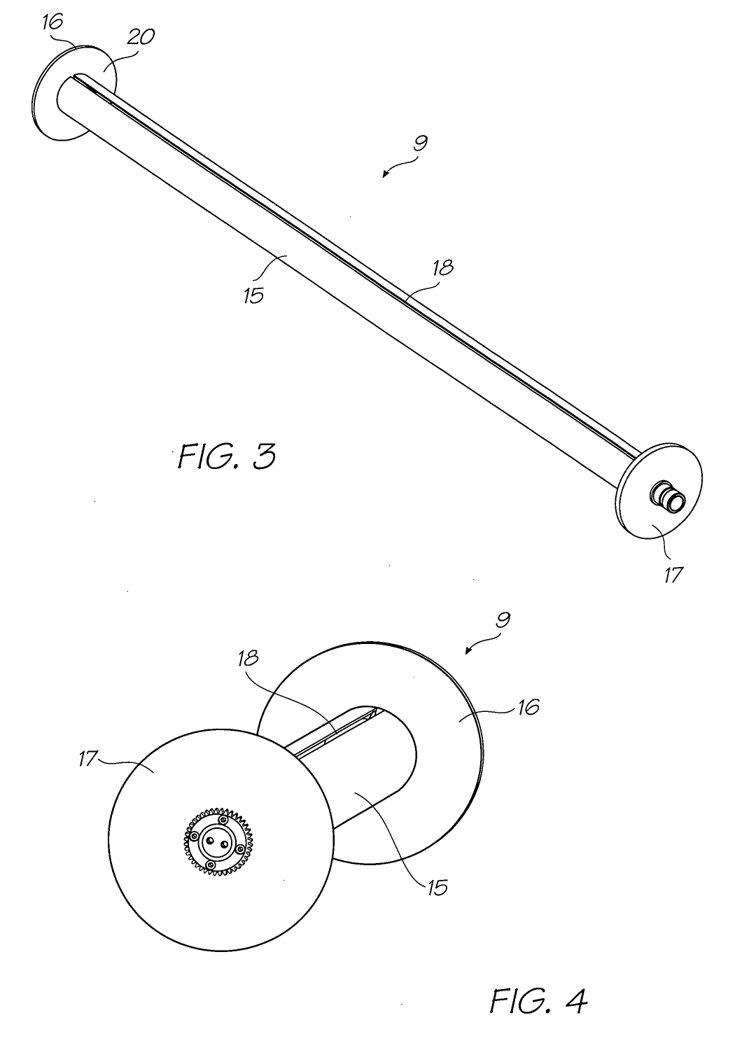

The take-up spool 9 will now be described in further detail with reference to FIGS. 3 to 6. The take-up spool 9 comprises a radially expandable shaft 15 and a pair of expander plugs 16 and 17, each expander plug engaged with a respective end of the shaft. The expander plugs 16 and 17 are releasably engaged in the ends of the shaft 15 by sliding friction-fitting engagement. The expander plugs 16 and 17 are shaped so that the shaft 15 is urged into a radially expanded configuration when the expander plugs are inserted in the ends of the shaft. The radial expansion is maximal at the ends of the shaft and minimal (or virtually negligible) at the centre of the shaft.

The shaft 15 is formed from a resilient material so that when the expander plugs 16 and 17 are removed from the shaft, it springs back to a radially contracted configuration. By contrast, the expander plugs 16 and 17 are relatively rigid so that their engagement with the shaft urges the shaft into a radially expanded configuration. In this preferred embodiment, both the shaft 15 and the expander plugs 16 and 17 are formed from aluminium, the expander plugs being relatively more rigid than the shaft by virtue of their thick-walled construction.

A longitudinal slit 18 extends along the length of the shaft 15. The longitudinal slit 18 facilitates radial expansion of the shaft. The longitudinal edges of the slit 18 are urged apart, increasing the slit width, when the expander plugs 16 and 17 are inserted in each end of the shaft. The longitudinal slit 18 additionally assists in capturing the web 5 on the take-up spool 9. This will be described in more detail below.

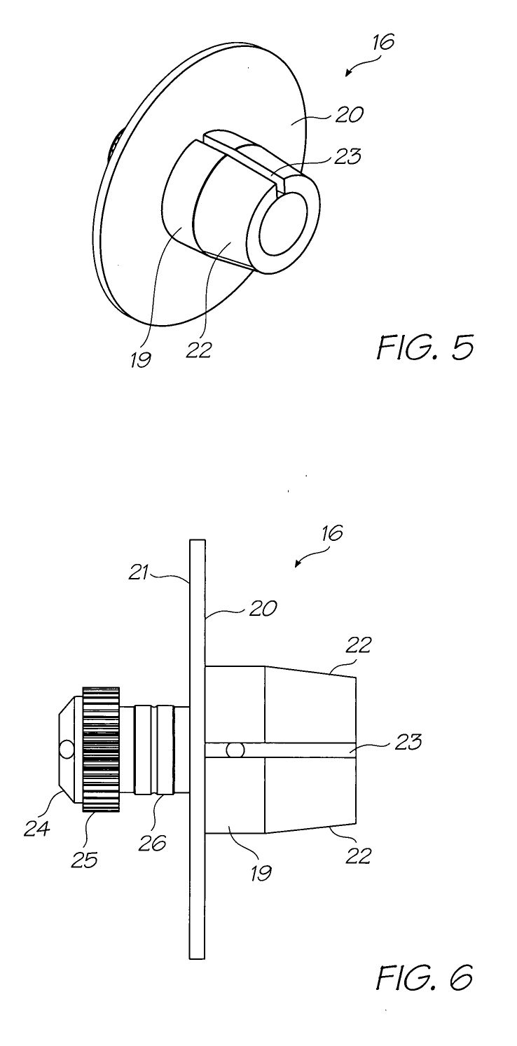

Turning now to FIGS. 5 and 6, the expander plug 16 comprises a hollow stub 19 having a circumferential flange 20 formed by a circular end-plate 21 at one end of the stub. It can seen from FIG. 3 that the flange 20 lies flush against one end of the shaft 15 and serves to guide the web 5 onto the take-up spool 9 as the web is being wound onto the spool. The stub 19 takes the form of a relatively thick-walled cylinder having tapered side walls 22. The side walls 22 taper inwardly at the distal end of the stub relative to the circular end-plate 21. The tapered side walls 22 allow the plug 16 to be easily inserted into the end of the shaft 15. As the plug is inserted, sliding abutment of the tapered side walls 22 against a circumferential end rim (not shown) of the shaft 15 urges the shaft into a radially expanded configuration.

The hollow stub 19 has a slit 23, which aligns with the longitudinal slit 18 in the shaft 15 when the expander plug 16 is inserted in the shaft. The stub 19 and the shaft 15 have complementary guides (not shown) for aligning the slits 18 and 23, and for minimizing rotational movement of the expander plug 16 relative to the shaft 15 as the take-up spool 9 is rotated.

FIG. 6 shows a connector arm 24 extending from the opposite face of the circular end-plate 21 relative to the stub 19. The connector arm 24 operatively connects the take-up spool 9 to the take-up motor 14 via a gear wheel 25 on the connector arm. The connector arm 24 also has a bearing 26, which facilitates free rotation of the connector arm and, hence, the take-up spool 9. The expander plug 17 also has a connector arm (not shown). However, the expander plug 17 is not operatively connected to the take-up motor 14 and, hence, its connector arm comprises only a bearing (not shown) and not a gear wheel.

A typical printing operation will now be described, which utilizes the advantageous features of the present invention. The take-up spool 9 is fitted in the wide format printer 1 and is operatively connected to the take-up motor 14 via gear wheel 25. The take-up spool 9 is in a radially expanded configuration by virtue of the two expander plugs 16 and 17 engaged at either end of the elongate shaft 15. Further, the slits 23 in each expander plug are aligned with the longitudinal slit 18 in the shaft 15.

A leading edge of the web 5 is fed manually into the longitudinal slit 18. After a portion of the web 5 is inserted in the longitudinal slit 18, the take-up spool 9 is then rotated manually until the web 5 is secured onto the take-up spool. Once the web 5 is secured to the take-up spool 9, automated printing is started by simultaneously feeding the web past the printhead 4 using the feed mechanism 3 whilst ejecting ink droplets from the printhead 4. A computer control system (not shown) controls the motors 12, 13 and 14 and also controls firing of the plurality of ink ejection nozzles (not shown) in the printhead 4. The web 5 having an image printed thereon is wound onto the take-up spool 9 during printing.

Once printing is completed, the web 5 is cut, if required, between the idle roller 8 and the take-up spool 9. The take-up spool 9 is then removed from the printer 1 and the expander plugs 16 and 17 removed from the shaft 15. Removal of the expander plugs 16 and 17 causes the shaft 15 to contract radially by virtue of the resilient biasing of the shaft. The roll of printed web, having a core diameter greater than that of the shaft 15, is then removed from the shaft by longitudinally sliding the shaft relative to the roll of printed web. The expander plugs 16 and 17 are then reinserted in the shaft 15 and the take-up spool 9 placed back in the printer 1 ready for the next print job.

It will, of course, be appreciated that the present invention has been described purely by way of example and that modifications of detail may be made within the scope of the invention, which is defined by the accompanying claims.

1. A spool for a printer comprising:
a radially expandable shaft comprising a longitudinal slit facilitating radial expansion and contraction of said expandable shaft, said longitudinal slit receiving a leading edge of a web; and
at least one expander releasably engageable with said shaft, said at least one expander comprising a stub having a tapered side wall that engages an inner wall of said expandable shaft and a slit in said side wall extending to a distal end of said stub, wherein engagement of said expander with said shaft radially expands at least part of said shaft and wherein said slit of said stub aligns with said longitudinal slit of said shaft.

2. The spool of claim 1, wherein said shaft is expandable from a radially contracted configuration to a radially expanded configuration, said shaft being resiliently biased towards said radially contracted configuration.

3. The spool of claim 1 comprising two expanders, wherein each expander is releasably engageable with a respective end of said shaft.

4. The spool of claim 1, wherein said shaft is hollow and said expander is an expander plug releasably engageable in said shaft.

5. The spool of claim 4, wherein said expander plug is friction-fitted in said shaft.

6. The spool of claim 5, wherein said expander plug is tapered for friction-fitting expanding engagement in said shaft.

7. The spool of claim 4, wherein said expander plug further comprises a flange for guiding a web of material onto said spool.

8.-10. (canceled)

11. The spool of claim 4, wherein said expander plug further comprises a connector arm for operatively connecting the spool to a motor.

12. The spool of claim 1, which is a take-up spool for a wide format printer.

13. A spool assembly comprising the spool of claim 11 operatively connected to the motor.

14. A wide format printer comprising:
a printhead; and
a feed mechanism for feeding a web of print media past said printhead, said feed mechanism comprising:
a supply spool;
a take-up spool as defined in claim 1; and
a take-up motor operatively connected to said take-up spool.

15. The printer of claim 14, wherein said printhead is a pagewidth inkjet printhead.
